(19) United States
(12) Patent Application Publication
(10) Pub. No.: US 2025/0278235 A1
(43) Pub. Date: Sep. 4, 2025

(54) Evaluating Calibration of a Playback Device

(71) Applicant: Sonos, Inc., Goleta, CA (US)

(72) Inventors: Romi Kadri, Cambridge, MA (US); Christopher Butts, Chicago, IL (US); Timothy Sheen, Brighton, MA (US); Simon Jarvis, Cambridge, MA (US)

(21) Appl. No.: 19/084,365

(22) Filed: Mar. 19, 2025

Related U.S. Application Data
(63) Continuation of application No. 17/458,673, filed on Aug. 27, 2021.
Application No. 17/458,673 is a continuation of application No. 15/005,496, filed on Jan. 25, 2016, now Pat. No. 11,106,423.

(51) Int. Cl. G06F 3/16; H04R 27/00; H04S 7/00

(52) U.S. Cl. CPC G06F 3/16; H04R 27/00; H04R 2227/003; H04R 2227/005; H04S 7/301

(57) ABSTRACT

An example method may include recording, via a microphone of a first playback device, audio played by a second playback device in accordance with a calibration setting. The method may further include, based on the recorded audio, determining that the calibration setting is invalid. The method may further include, in response to determining that the calibration setting is invalid, sending an indication that the calibration setting is invalid. This disclosure also includes example non-transitory computer readable media and playback devices that are related to the example method.

### CROSS REFERENCE TO RELATED APPLICATIONS

This application is a continuation of U.S. patent application Ser. No. 17/458,673, filed on Aug. 27, 2021, which is a continuation of U.S. patent application Ser. No. 15/005,496, filed on Jan. 25, 2016, each of which is incorporated by reference in its entirety.

### FIELD OF THE DISCLOSURE

The disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The Sonos Wireless HiFi System enables people to experience music from many sources via one or more networked playback devices. Through a software control application installed on a smartphone, tablet, or computer, one can play what he or she wants in any room that has a networked playback device. Additionally, using the controller, for example, different songs can be streamed to each room with a playback device, rooms can be grouped together for synchronous playback, or the same song can be heard in all rooms synchronously.

Given the ever growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings where:

FIG. 1 shows an example media playback system configuration in which certain embodiments may be practiced;

FIG. 2 shows a functional block diagram of an example playback device;

FIG. 3 shows a functional block diagram of an example control device;

FIG. 4 shows an example controller interface;

FIG. 5 shows a flow diagram of an example method;

FIG. 6 shows a flow diagram of another example method; and

FIG. 7 shows a display of an example control device.

The drawings are for the purpose of illustrating example embodiments, but it is understood that the inventions are not limited to the arrangements and instrumentality shown in the drawings.

### DETAILED DESCRIPTION

### I. Overview

The audio response of a playback device may vary based on how the playback device is positioned and oriented within an environment such as a room. For instance, the audio response may vary based on whether the playback device is placed near the center of the room or in a corner of the room, based on whether the playback device is oriented to emit sound waves toward the center of the room or toward a nearby wall, or based on the placement of various items within the room. For example, various items within the room, such as walls or furniture, may reflect and/or absorb sound waves emitted by the playback device. At some locations within the room, some or all frequencies of audio played by the playback device may be perceived to be amplified or attenuated with respect to audio perceived at other locations within the room. In addition, the room may exhibit too much or too little reverberation for desirable listening.

As such, it may be beneficial for a playback device to be calibrated based on the room in which the playback device is to play audio. That is, a calibration setting of the playback device may be adjusted to compensate for the room such that a desirable frequency response, temporal response, and/or spatial response are exhibited by the playback device within the room. Playback of audio according to the calibration setting may include amplification or attenuation of various audio frequencies, amplification or attenuation of audio signals provided to various audio drivers, and/or increasing or reducing a reverberation setting of the playback device, among other examples.

After calibration, characteristics of the room may change and/or the playback device may be repositioned or reoriented, which may render the calibration ineffective to yield the desired audio response from the playback device. For example, a large item of furniture may be added to the room or tapestries or pictures may be hung on a wall of the room. Endless other such examples of changes in characteristics of the room exist. Such changes may render the calibration invalid.

To help alleviate this problem, a first playback device may be used to check whether the calibration setting of a second playback device is still valid. For example, the first playback device may use a microphone to record audio played by the second playback device in accordance with the calibration setting. Based on the recorded audio, the first playback device may compare the recorded audio to an audio response that is expected if the calibration setting was still valid. For instance, the expected audio response may be defined by a particular frequency response and/or a particular level of reverberation. In examples where the first playback device determines that the calibration setting is invalid, the first playback device may send an indication that the calibration setting is invalid. The indication might be sent to the second playback device, a control device, or another device. A device that receives the indication may, in some cases, responsively initiate recalibration of the second playback device.

Accordingly, some examples described herein include, among other things, a first playback device recording audio played by a second playback device in accordance with a calibration setting, the first playback device using the recorded audio to determine that the calibration setting of the second playback device is invalid, and sending, to another device, an indication that the calibration setting is invalid. Other aspects of the examples will be made apparent in the remainder of the description herein.

In one example, a first playback device includes one or more processors, a microphone, and a non-transitory computer readable medium storing instructions that, when executed by the one or more processors, cause the first playback device to perform functions. The functions include recording, via the microphone, audio played by a second playback device in accordance with a calibration setting. The functions further include, based on the recorded audio, determining that the calibration setting is invalid. The functions further include, in response to determining that the calibration setting is invalid, sending an indication that the calibration setting is invalid.

In another example, a method includes recording, via a microphone of a first playback device, audio played by a second playback device in accordance with a calibration setting. The method further includes, based on the recorded audio, determining that the calibration setting is invalid. The method further includes, in response to determining that the calibration setting is invalid, sending an indication that the calibration setting is invalid.

In yet another example, a non-transitory computer readable medium stores instructions that, when executed by a first playback device, cause the first playback device to perform functions. The functions include recording, via a microphone of the first playback device, audio played by a second playback device in accordance with a calibration setting. The functions further include, based on the recorded audio, determining that the calibration setting is invalid. The functions further include, in response to determining that the calibration setting is invalid, sending an indication that the calibration setting is invalid.

It will be understood by one of ordinary skill in the art that this disclosure includes numerous other embodiments. While some examples described herein may refer to functions performed by given actors such as “users” and/or other entities, it should be understood that this is for purposes of explanation only. The claims should not be interpreted to require action by any such example actor unless explicitly required by the language of the claims themselves.

### II. Example Operating Environment

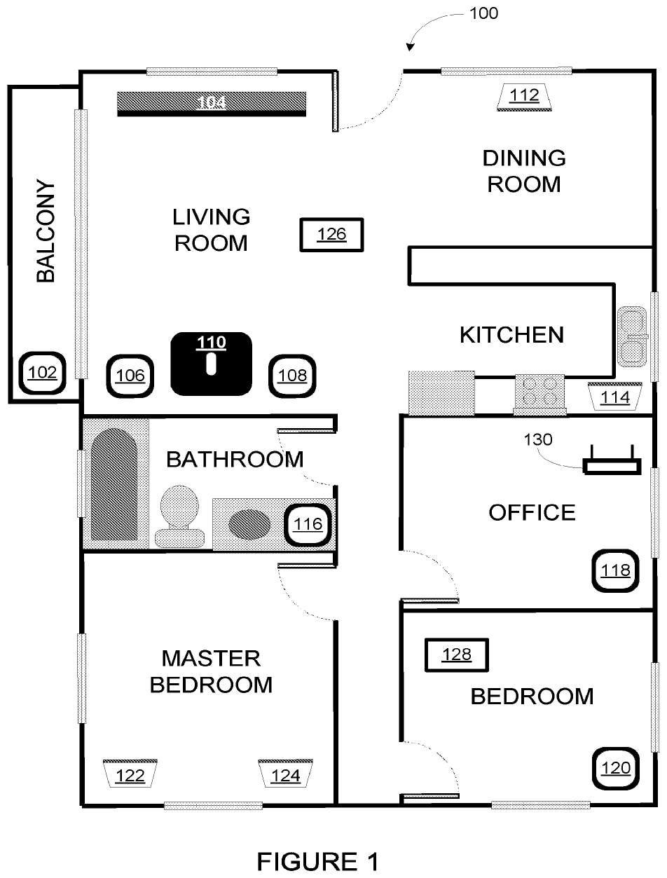

FIG. 1 shows an example configuration of a media playback system 100 in which one or more embodiments disclosed herein may be practiced or implemented. The media playback system 100 as shown is associated with an example home environment having several rooms and spaces, such as for example, a master bedroom, an office, a dining room, and a living room. As shown in the example of FIG. 1, the media playback system 100 includes playback devices 102, 104, 106, 108, 110, 112, 114, 116, 118, 120, 122, and 124, control devices 126 and 128, and a wired or wireless network router 130.

Further discussions relating to the different components of the example media playback system 100 and how the different components may interact to provide a user with a media experience may be found in the following sections. While discussions herein may generally refer to the example media playback system 100, technologies described herein are not limited to applications within, among other things, the home environment as shown in FIG. 1. For instance, the technologies described herein may be useful in environments where multi-zone audio may be desired, such as, for example, a commercial setting like a restaurant, mall or airport, a vehicle like a sports utility vehicle (SUV), bus or car, a ship or boat, an airplane, and so on.

a. Example Playback Devices

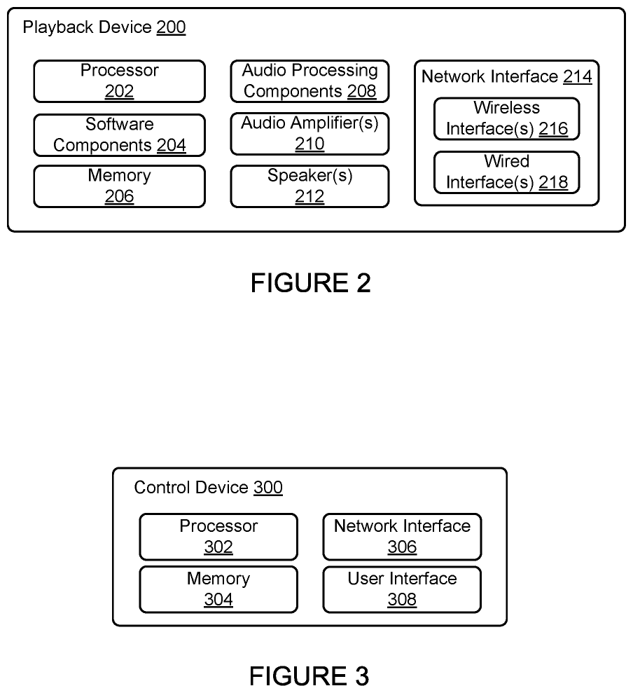

FIG. 2 shows a functional block diagram of an example playback device 200 that may be configured to be one or more of the playback devices 102-124 of the media playback system 100 of FIG. 1. The playback device 200 may include a processor 202, software components 204, memory 206, audio processing components 208, audio amplifier(s) 210, speaker(s) 212, and a network interface 214 including wireless interface(s) 216 and wired interface(s) 218. In one case, the playback device 200 might not include the speaker(s) 212, but rather a speaker interface for connecting the playback device 200 to external speakers. In another case, the playback device 200 may include neither the speaker(s) 212 nor the audio amplifier(s) 210, but rather an audio interface for connecting the playback device 200 to an external audio amplifier or audio-visual receiver.

In one example, the processor 202 may be a clock-driven computing component configured to process input data according to instructions stored in the memory 206. The memory 206 may be a tangible computer-readable medium configured to store instructions executable by the processor 202. For instance, the memory 206 may be data storage that can be loaded with one or more of the software components 204 executable by the processor 202 to achieve certain functions. In one example, the functions may involve the playback device 200 retrieving audio data from an audio source or another playback device. In another example, the functions may involve the playback device 200 sending audio data to another device or playback device on a network. In yet another example, the functions may involve pairing of the playback device 200 with one or more playback devices to create a multi-channel audio environment.

Certain functions may involve the playback device 200 synchronizing playback of audio content with one or more other playback devices. During synchronous playback, a listener will preferably not be able to perceive time-delay differences between playback of the audio content by the playback device 200 and the one or more other playback devices. U.S. Pat. No. 8,234,395 entitled, “System and method for synchronizing operations among a plurality of independently clocked digital data processing devices,” which is hereby incorporated by reference, provides in more detail some examples for audio playback synchronization among playback devices.

The memory 206 may further be configured to store data associated with the playback device 200, such as one or more zones and/or zone groups the playback device 200 is a part of, audio sources accessible by the playback device 200, or a playback queue that the playback device 200 (or some other playback device) may be associated with. The data may be stored as one or more state variables that are periodically updated and used to describe the state of the playback device 200. The memory 206 may also include the data associated with the state of the other devices of the media system, and shared from time to time among the devices so that one or more of the devices have the most recent data associated with the system. Other embodiments are also possible.

The audio processing components 208 may include one or more digital-to-analog converters (DAC), an audio preprocessing component, an audio enhancement component or a digital signal processor (DSP), and so on. In one embodiment, one or more of the audio processing components 208 may be a subcomponent of the processor 202. In one example, audio content may be processed and/or intentionally altered by the audio processing components 208 to produce audio signals. The produced audio signals may then be provided to the audio amplifier(s) 210 for amplification and playback through speaker(s) 212. Particularly, the audio amplifier(s) 210 may include devices configured to amplify audio signals to a level for driving one or more of the speakers 212. The speaker(s) 212 may include an individual transducer (e.g., a “driver”) or a complete speaker system involving an enclosure with one or more drivers. A particular driver of the speaker(s) 212 may include, for example, a subwoofer (e.g., for low frequencies), a mid-range driver (e.g., for middle frequencies), and/or a tweeter (e.g., for high frequencies). In some cases, each transducer in the one or more speakers 212 may be driven by an individual corresponding audio amplifier of the audio amplifier(s) 210. In addition to producing analog signals for playback by the playback device 200, the audio processing components 208 may be configured to process audio content to be sent to one or more other playback devices for playback.

Audio content to be processed and/or played back by the playback device 200 may be received from an external source, such as via an audio line-in input connection (e.g., an auto-detecting 3.5 mm audio line-in connection) or the network interface 214.

The microphone(s) 220 may include an audio sensor configured to convert detected sounds into electrical signals. The electrical signal may be processed by the audio processing components 208 and/or the processor 202. The microphone(s) 220 may be positioned in one or more orientations at one or more locations on the playback device 200. The microphone(s) 220 may be configured to detect sound within one or more frequency ranges. In one case, one or more of the microphone(s) 220 may be configured to detect sound within a frequency range of audio that the playback device 200 is capable or rendering. In another case, one or more of the microphone(s) 220 may be configured to detect sound within a frequency range audible to humans. Other examples are also possible.

The network interface 214 may be configured to facilitate a data flow between the playback device 200 and one or more other devices on a data network. As such, the playback device 200 may be configured to receive audio content over the data network from one or more other playback devices in communication with the playback device 200, network devices within a local area network, or audio content sources over a wide area network such as the Internet. In one example, the audio content and other signals transmitted and received by the playback device 200 may be transmitted in the form of digital packet data containing an Internet Protocol (IP)-based source address and IP-based destination addresses. In such a case, the network interface 214 may be configured to parse the digital packet data such that the data destined for the playback device 200 is properly received and processed by the playback device 200.

As shown, the network interface 214 may include wireless interface(s) 216 and wired interface(s) 218. The wireless interface(s) 216 may provide network interface functions for the playback device 200 to wirelessly communicate with other devices (e.g., other playback device(s), speaker(s), receiver(s), network device(s), control device(s) within a data network the playback device 200 is associated with) in accordance with a communication protocol (e.g., any wireless standard including IEEE 802.11a, 802.11b, 802.11g, 802.11n, 802.11ac, 802.15, 4G mobile communication standard, and so on). The wired interface(s) 218 may provide network interface functions for the playback device 200 to communicate over a wired connection with other devices in accordance with a communication protocol (e.g., IEEE 802.3). While the network interface 214 shown in FIG. 2 includes both wireless interface(s) 216 and wired interface(s) 218, the network interface 214 may in some embodiments include only wireless interface(s) or only wired interface(s).

In one example, the playback device 200 and one other playback device may be paired to play two separate audio components of audio content. For instance, playback device 200 may be configured to play a left channel audio component, while the other playback device may be configured to play a right channel audio component, thereby producing or enhancing a stereo effect of the audio content. The paired playback devices (also referred to as “bonded playback devices”) may further play audio content in synchrony with other playback devices.

In another example, the playback device 200 may be sonically consolidated with one or more other playback devices to form a single, consolidated playback device. A consolidated playback device may be configured to process and reproduce sound differently than an unconsolidated playback device or playback devices that are paired, because a consolidated playback device may have additional speaker drivers through which audio content may be rendered. For instance, if the playback device 200 is a playback device designed to render low frequency range audio content (i.e. a subwoofer), the playback device 200 may be consolidated with a playback device designed to render full frequency range audio content. In such a case, the full frequency range playback device, when consolidated with the low frequency playback device 200, may be configured to render only the mid and high frequency components of audio content, while the low frequency range playback device 200 renders the low frequency component of the audio content. The consolidated playback device may further be paired with a single playback device or yet another consolidated playback device.

By way of illustration, SONOS, Inc. presently offers (or has offered) for sale certain playback devices including a “PLAY:1,” “PLAY:3,” “PLAY:5,” “PLAYBAR,” “CONNECT: AMP,” “CONNECT,” and “SUB.” Any other past, present, and/or future playback devices may additionally or alternatively be used to implement the playback devices of example embodiments disclosed herein. Additionally, it is understood that a playback device is not limited to the example illustrated in FIG. 2 or to the SONOS product offerings. For example, a playback device may include a wired or wireless headphone. In another example, a playback device may include or interact with a docking station for personal mobile media playback devices. In yet another example, a playback device may be integral to another device or component such as a television, a lighting fixture, or some other device for indoor or outdoor use.

b. Example Playback Zone Configurations

Referring back to the media playback system 100 of FIG. 1, the environment may have one or more playback zones, each with one or more playback devices. The media playback system 100 may be established with one or more playback zones, after which one or more zones may be added, or removed to arrive at the example configuration shown in FIG. 1. Each zone may be given a name according to a different room or space such as an office, bathroom, master bedroom, bedroom, kitchen, dining room, living room, and/or balcony. In one case, a single playback zone may include multiple rooms or spaces. In another case, a single room or space may include multiple playback zones.

As shown in FIG. 1, the balcony, dining room, kitchen, bathroom, office, and bedroom zones each have one playback device, while the living room and master bedroom zones each have multiple playback devices. In the living room zone, playback devices 104, 106, 108, and 110 may be configured to play audio content in synchrony as individual playback devices, as one or more bonded playback devices, as one or more consolidated playback devices, or any combination thereof. Similarly, in the case of the master bedroom, playback devices 122 and 124 may be configured to play audio content in synchrony as individual playback devices, as a bonded playback device, or as a consolidated playback device.

In one example, one or more playback zones in the environment of FIG. 1 may each be playing different audio content. For instance, the user may be grilling in the balcony zone and listening to hip hop music being played by the playback device 102 while another user may be preparing food in the kitchen zone and listening to classical music being played by the playback device 114. In another example, a playback zone may play the same audio content in synchrony with another playback zone. For instance, the user may be in the office zone where the playback device 118 is playing the same rock music that is being played by playback device 102 in the balcony zone. In such a case, playback devices 102 and 118 may be playing the rock music in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the media playback system 100 may be dynamically modified, and in some embodiments, the media playback system 100 supports numerous configurations. For instance, if a user physically moves one or more playback devices to or from a zone, the media playback system 100 may be reconfigured to accommodate the change(s). For instance, if the user physically moves the playback device 102 from the balcony zone to the office zone, the office zone may now include both the playback device 118 and the playback device 102. The playback device 102 may be paired or grouped with the office zone and/or renamed if so desired via a control device such as the control devices 126 and 128. On the other hand, if the one or more playback devices are moved to a particular area in the home environment that is not already a playback zone, a new playback zone may be created for the particular area.

Further, different playback zones of the media playback system 100 may be dynamically combined into zone groups or split up into individual playback zones. For instance, the dining room zone and the kitchen zone 114 may be combined into a zone group for a dinner party such that playback devices 112 and 114 may render audio content in synchrony. On the other hand, the living room zone may be split into a television zone including playback device 104, and a listening zone including playback devices 106, 108, and 110, if the user wishes to listen to music in the living room space while another user wishes to watch television.

c. Example Control Devices

FIG. 3 shows a functional block diagram of an example control device 300 that may be configured to be one or both of the control devices 126 and 128 of the media playback system 100. As shown, the control device 300 may include a processor 302, memory 304, a network interface 306, and a user interface 308. In one example, the control device 300 may be a dedicated controller for the media playback system 100. In another example, the control device 300 may be a network device on which media playback system controller application software may be installed, such as for example, an iPhone™ iPad™ or any other smart phone, tablet or network device (e.g., a networked computer such as a PC or Mac™).

The processor 302 may be configured to perform functions relevant to facilitating user access, control, and configuration of the media playback system 100. The memory 304 may be configured to store instructions executable by the processor 302 to perform those functions. The memory 304 may also be configured to store the media playback system controller application software and other data associated with the media playback system 100 and the user.

The microphone(s) 310 may include an audio sensor configured to convert detected sounds into electrical signals. The electrical signal may be processed by the processor 302. In one case, if the control device 300 is a device that may also be used as a means for voice communication or voice recording, one or more of the microphone(s) 310 may be a microphone for facilitating those functions. For instance, the one or more of the microphone(s) 310 may be configured to detect sound within a frequency range that a human is capable of producing and/or a frequency range audible to humans. Other examples are also possible.

In one example, the network interface 306 may be based on an industry standard (e.g., infrared, radio, wired standards including IEEE 802.3, wireless standards including IEEE 802.11a, 802.11b, 802.11g, 802.11n, 802.11ac, 802.15, 4G mobile communication standard, and so on). The network interface 306 may provide a means for the control device 300 to communicate with other devices in the media playback system 100. In one example, data and information (e.g., such as a state variable) may be communicated between control device 300 and other devices via the network interface 306. For instance, playback zone and zone group configurations in the media playback system 100 may be received by the control device 300 from a playback device or another network device, or transmitted by the control device 300 to another playback device or network device via the network interface 306. In some cases, the other network device may be another control device.

Playback device control commands such as volume control and audio playback control may also be communicated from the control device 300 to a playback device via the network interface 306. As suggested above, changes to configurations of the media playback system 100 may also be performed by a user using the control device 300. The configuration changes may include adding/removing one or more playback devices to/from a zone, adding/removing one or more zones to/from a zone group, forming a bonded or consolidated player, separating one or more playback devices from a bonded or consolidated player, among others. Accordingly, the control device 300 may sometimes be referred to as a controller, whether the control device 300 is a dedicated controller or a network device on which media playback system controller application software is installed.

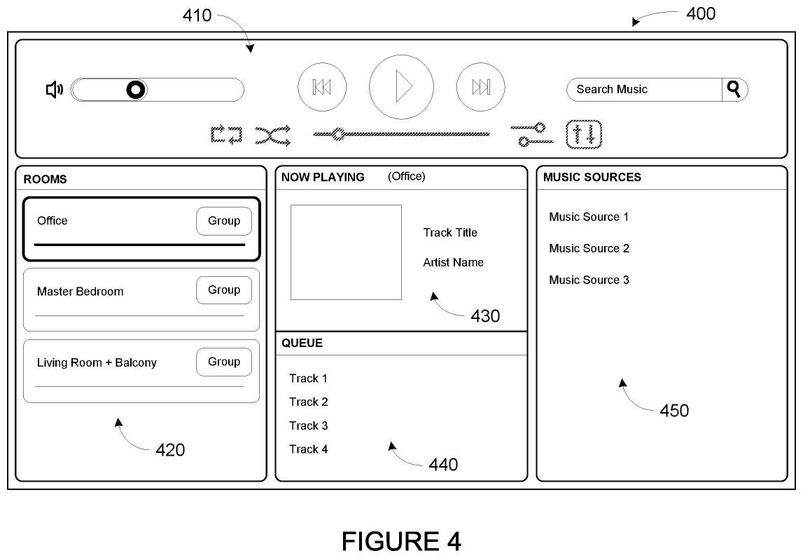

The user interface 308 of the control device 300 may be configured to facilitate user access and control of the media playback system 100, by providing a controller interface such as the controller interface 400 shown in FIG. 4. The controller interface 400 includes a playback control region 410, a playback zone region 420, a playback status region 430, a playback queue region 440, and an audio content sources region 450. The user interface 400 as shown is just one example of a user interface that may be provided on a network device such as the control device 300 of FIG. 3 (and/or the control devices 126 and 128 of FIG. 1) and accessed by users to control a media playback system such as the media playback system 100. Other user interfaces of varying formats, styles, and interactive sequences may alternatively be implemented on one or more network devices to provide comparable control access to a media playback system.

The playback control region 410 may include selectable (e.g., by way of touch or by using a cursor) icons to cause playback devices in a selected playback zone or zone group to play or pause, fast forward, rewind, skip to next, skip to previous, enter/exit shuffle mode, enter/exit repeat mode, enter/exit cross fade mode. The playback control region 410 may also include selectable icons to modify equalization settings, and playback volume, among other possibilities.

The playback zone region 420 may include representations of playback zones within the media playback system 100. In some embodiments, the graphical representations of playback zones may be selectable to bring up additional selectable icons to manage or configure the playback zones in the media playback system, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface such as the user interface 400 are also possible. The representations of playback zones in the playback zone region 420 may be dynamically updated as playback zone or zone group configurations are modified.

The playback status region 430 may include graphical representations of audio content that is presently being played, previously played, or scheduled to play next in the selected playback zone or zone group. The selected playback zone or zone group may be visually distinguished on the user interface, such as within the playback zone region 420 and/or the playback status region 430. The graphical representations may include track title, artist name, album name, album year, track length, and other relevant information that may be useful for the user to know when controlling the media playback system via the user interface 400.

The playback queue region 440 may include graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streaming audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped. Other examples are also possible.

Referring back to the user interface 400 of FIG. 4, the graphical representations of audio content in the playback queue region 440 may include track titles, artist names, track lengths, and other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device.

The audio content sources region 450 may include graphical representations of selectable audio content sources from which audio content may be retrieved and played by the selected playback zone or zone group. Discussions pertaining to audio content sources may be found in the following section.

d. Example Audio Content Sources

As indicated previously, one or more playback devices in a zone or zone group may be configured to retrieve for playback audio content (e.g. according to a corresponding URI or URL for the audio content) from a variety of available audio content sources. In one example, audio content may be retrieved by a playback device directly from a corresponding audio content source (e.g., a line-in connection). In another example, audio content may be provided to a playback device over a network via one or more other playback devices or network devices.

Example audio content sources may include a memory of one or more playback devices in a media playback system such as the media playback system 100 of FIG. 1, local music libraries on one or more network devices (such as a control device, a network-enabled personal computer, or a networked-attached storage (NAS), for example), streaming audio services providing audio content via the Internet (e.g., the cloud), or audio sources connected to the media playback system via a line-in input connection on a playback device or network devise, among other possibilities.

In some embodiments, audio content sources may be regularly added or removed from a media playback system such as the media playback system 100 of FIG. 1. In one example, an indexing of audio items may be performed whenever one or more audio content sources are added, removed or updated. Indexing of audio items may involve scanning for identifiable audio items in all folders/directory shared over a network accessible by playback devices in the media playback system, and generating or updating an audio content database containing metadata (e.g., title, artist, album, track length, among others) and other associated information, such as a URI or URL for each identifiable audio item found. Other examples for managing and maintaining audio content sources may also be possible.

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

### III. Example Methods Related to Evaluating Calibration of a Playback Device

As discussed above, some examples described herein include, among other things, a first playback device recording audio played by a second playback device in accordance with a calibration setting, the first playback device using the recorded audio to determine that the calibration setting of the second playback device is invalid, and sending, to another device, an indication that the calibration setting is invalid. Other aspects of the examples will be made apparent in the remainder of the description herein.

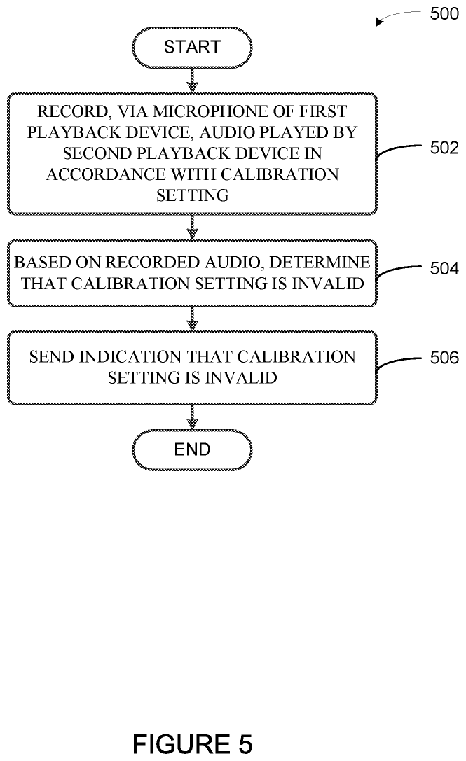

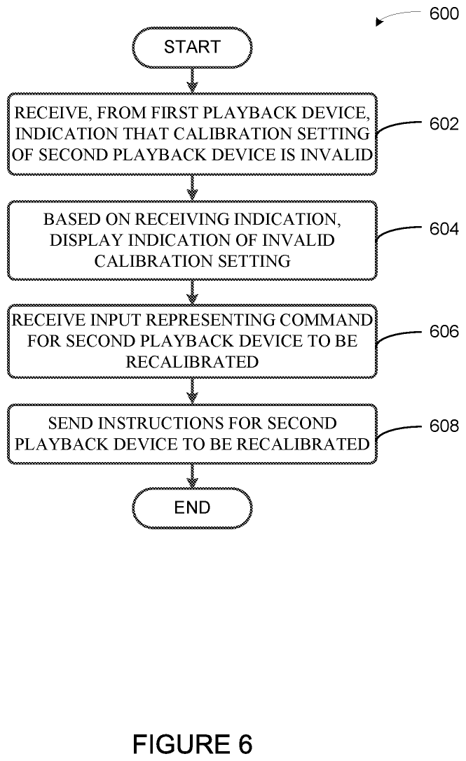

The methods 500 and 600 shown in FIGS. 5 and 6 present example methods that can be implemented within an operating environment including, for example, one or more of the media playback system 100 of FIG. 1, one or more of the playback device 200 of FIG. 2, and one or more of the control device 300 of FIG. 3. The methods 500 and 600 may involve other devices as well. The methods 500 and 600 may include one or more operations, functions, or actions as illustrated by one or more of blocks 502, 504, 506, 602, 604, 606, and 608. Although the blocks are illustrated in sequential order, these blocks may also be performed in parallel, and/or in a different order than those described herein. Also, the various blocks may be combined into fewer blocks, divided into additional blocks, and/or removed based upon the desired implementation.

In addition, for the methods 500 and 600 and other processes and methods disclosed herein, the flowcharts show functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer-readable medium, for example, such as a storage device including a disk(s) or hard drive(s). In some embodiments, the program code may be stored in memory (e.g., disks or disk arrays) associated with and/or connected to a server system that makes the program code available for download (e.g., an application store or other type of server system) to desktop/laptop computers, smart phones, tablet computers, or other types of computing devices. The computer-readable medium may include non-transitory computer-readable media, for example, such as computer-readable media that stores data for short periods of time like register memory, processor cache, and Random Access Memory (RAM). The computer-readable medium may also include non-transitory media, such as secondary or persistent long-term storage, like read-only memory (ROM), optical or magnetic disks, compact-disc read-only memory (CD-ROM), for example. The computer-readable media may also be any other volatile or non-volatile storage systems. The computer-readable medium may be considered a computer-readable storage medium, for example, or a tangible storage device. In addition, for the methods 500 and 600 and other processes and methods disclosed herein, each block in FIGS. 5 and 6 may represent circuitry that is wired to perform the specific logical functions in the process.

In some examples, the playback device 104 may perform functions prior to performing the method 500. For example, the playback device 104 may record audio played by the playback device 106 in accordance with a calibration setting of the playback device 106 (e.g., the calibration setting described below with reference to blocks 502-506). The playback device 106 might play the audio immediately or shortly after the calibration setting of the playback device 106 is set, but other examples are possible. Based on the recorded audio, the playback device 104 may determine that the calibration setting is valid, perhaps in a manner similar to how the playback device 104 may determine, as described below with reference to block 504, that the calibration setting of the playback device 106 is invalid. Next, the playback device 104 may initiate performance of the method 500 based on a predetermined amount of time passing since determining that the calibration setting is valid, or based on some other trigger event, as described below.

Although much of the functionality described herein related to the method 500 is depicted as being performed by the playback device 104, any other network-enabled computing device that includes a microphone may perform this functionality as well.

At block 502, the method 500 includes recording, via a microphone of a first playback device, audio played by a second playback device in accordance with a calibration setting. Block 502 may be triggered by several types of events. For example, the playback device 104 may record audio played by the playback device 106 in response to the playback device 104 detecting motion within the room. Such motion might include motion of a person, furniture, another playback device, or the playback device 104, among other examples. The playback device 104 might detect such motion via an optical or acoustic motion sensor or an accelerometer, for example.

In other examples, the playback device 104 may record audio played by the playback device 106 in response to receiving a message from another playback device. For example, the playback device 104 may receive a message from the playback device 108 indicating that the playback device 108 performed an evaluation of the calibration setting of the playback device 106 from the perspective of the playback device 108. The message may include audio played by the playback device 106 and recorded by the playback device 108 or data indicating whether the playback device 108 determined that the playback device 106 was properly calibrated. The message might also indicate that the playback device 108 detected motion within the room.

Referring to FIG. 1 for example, during an arbitrary time interval t₁, the playback device 104 may record, via a microphone, audio played by the playback device 106. The playback device 106 may play the audio in accordance with a calibration setting. (Hereinafter, any difference between a time interval during which audio is played and a time interval during which corresponding audio is recorded will be assumed to be negligible, unless specifically noted, for the sake of simplicity.) Prior to playing the audio recorded by the playback device 104, the playback device 106 may be calibrated in any manner described in the following disclosures, which are all incorporated by reference in their entirety: U.S. patent application Ser. No. 14/481,511, filed on Sep. 9, 2014; U.S. patent application Ser. No. 14/696,014, filed on Apr. 24, 2015; U.S. patent application Ser. No. 14/826,873, filed on Aug. 14, 2015; and U.S. patent application Ser. No. 14/864,393, filed on Sep. 24, 2015.

The calibration setting may include amplification or attenuation of various audio frequencies, amplification or attenuation of audio signals provided to different audio drivers of the playback device 106, and/or a reverberation setting. The calibration setting may involve other audio processing functionality as well. The audio played by the playback device 106 and recorded by the playback device 104 during the time interval t₁ may include a multi-frequency “test tone” that is designed for audio calibration, but the audio may also include music, spoken word, or other types of audio content.

In some examples, the playback device 104 may receive, from the playback device 106, a command to determine whether the calibration setting of the playback device 106 is invalid. The playback device 106 may send the command to the playback device 104 wirelessly, but other examples are possible. In this context, the playback device 104 may, during the time interval t₁, record the audio played by the playback device 106 in response to receiving the command from the playback device 106.

In another example, the playback device 104 may receive, from the control device 126, a command to determine whether the calibration setting of the playback device 106 is invalid. The control device 126 may send the command to the playback device 104 wirelessly (e.g., in response to user input), but other examples are possible. The playback device 104 may also receive the command from a server (not shown). In this context, the playback device 104 may, during the time interval t₁, record the audio played by the playback device 106 in response to receiving the command from the control device 126.

The method 500 may also involve the playback device 104 determining that a threshold amount of time has passed since the playback device 104 last determined whether the playback device 106 is correctly calibrated. In this context, the playback device 104 may, during the time interval t₁, record the audio played by the playback device 106 in response to determining that the threshold amount of time has passed since the playback device 104 last determined whether the playback device 106 is correctly calibrated. An example of a threshold amount of time may include 24 hours, 1 hour, or 30 minutes, but other examples are possible.

In some examples, the playback device 104 may receive audio data from one or more of the playback devices 108, 110, or 112, for example. The audio data may include audio played by the playback device 106 and recorded by one or more of the playback devices 108, 110, or 112. The playback device 104 may use the received audio data, along with audio captured by the playback device 104, to determine that the calibration setting of the playback device 106 is invalid, as described in more detail below.

In some examples, the playback device 104 might record audio played by the playback device 104 as part of a process to check calibration settings of the playback device 104.

At block 504, the method 500 includes, based on the recorded audio, determining that the calibration setting is invalid. For example, based on the audio played by the playback device 106 and recorded by the playback device 104 during the time interval t₁, the playback device 104 may determine that the calibration setting of the playback device 106 is invalid.

Block 504 may be triggered by several types of events. For example, the playback device 104 may determine whether the calibration setting of the playback device 106 is invalid in response to the playback device 104 detecting motion within the room, perhaps in one or more ways described above.

In other examples, the playback device 104 may determine whether the calibration setting of the playback device 106 is invalid in response to receiving a message from another playback device. For example, the playback device 104 may receive a message from the playback device 108 indicating that the playback device 108 performed an evaluation of the calibration setting of the playback device 106 from the perspective of the playback device 108. The message may include audio played by the playback device 106 and recorded by the playback device 108 or data indicating whether the playback device 108 determined that the playback device 106 was properly calibrated. The message might also indicate that the playback device 108 detected motion within the room.

By way of illustration, the playback device 104 determining the validity of the calibration setting of the playback device 106 might be performed according to the following equation:

$$\vert FFT ( {R}_{{t}_{1}} ) * {FFT}^{- 1} ( {R}_{{t}_{0}} ) - FFT ( source ) * {FFT}^{- 1} ( EQ ) \vert > T \qquad [ 1 ]$$

Terms of the equation [1] are defined in the table below:

| | |
|---|---|
| FFT | Fast Fourier Transform |
| FFT⁻¹ | Inverse Fast Fourier Transform |
| Rₜ_{₀} | Audio as played by the playback device 106 according |
| | to the calibration setting and recorded by the playback |
| | device 104 during the time interval t₀ that precedes t₁ |
| Rₜ_{₁} | Audio as played by the playback device 106 according |
| | to the calibration setting and the (optional) user- |
| | defined audio processing algorithm as recorded by |
| | the playback device 104 during the time interval t₁ |
| (source) | Source audio content played by the playback device |
| | 106 during the time intervals t₀ and t₁ |
| (EQ) | (Optional) user-defined audio processing algorithm |
| | applied in addition to the calibration setting for |
| | audio recorded during time interval t₁ |
| T | Threshold amount of difference |

The playback device 104 may determine, for at least a threshold number of frequency ranges, a first product of (a) the FFT of the audio recorded during the time interval t₁ and (b) the inverse FFT of the audio recorded during the time interval tₜ₀, and a second product of (c) the FFT of the source audio content and (d) the inverse FFT of the (optional) user-defined audio processing algorithm. If the absolute value of the difference between the first product and the second product exceeds a threshold amount “T,” then the calibration setting may be considered invalid. For example, invalidity of the calibration setting may correspond to at least 10% of the frequency ranges analyzed exhibiting differences that exceed the threshold amount “T.” Other numbers or percentages of frequency ranges may be used as the threshold number of frequency ranges as well. The threshold amount “T” might be equal to 1 dB, but other examples are possible.

Accordingly, the playback device 104 may determine, for at least a threshold number of frequency ranges, that the recorded audio Rₜ₁ differs by more than the threshold amount “T” from the expected audio response. The expected audio response may be represented by Rₜ₀, accounting for any discrepancies associated with the user-defined audio processing algorithm with the parameters “source” and “EQ.”

In some examples, the playback device 104 may determine that the recorded audio differs from the expected audio response by more than the threshold amount by determining that, for at least a threshold amount of frequency ranges, a first frequency response represented by the recorded audio differs by more than the threshold amount from a second frequency response represented by the expected audio response.

For instance, the playback device may analyze the frequency ranges of 2-5 kHz, 5-10 kHz, 10-15 kHz, and 15-20 kHz. By further example, the threshold amount of response difference may be +/−1 dB and the threshold amount of frequency ranges may be 1. That is, if any of the frequency ranges of 2-5 kHz, 5-10 kHz, 10-15 kHz, and 15-20 kHz corresponding to the recorded audio exhibit more than +/−1 dB difference from the expected audio response, the playback device 104 may determine that the calibration setting of the playback device 106 is invalid. Other frequency ranges, threshold amounts of response difference, and threshold amounts or percentages of frequency ranges are possible as well.

In another example, the playback device 104 may determine that a first temporal response represented by the audio recorded during the time interval t₁ differs by more than a threshold amount from a second temporal response represented by the expected audio response recorded during the time interval t₀.

More specifically, the playback device 104 may analyze various frequency ranges of the audio recorded during the time interval t₁ and the expected audio response recorded during the time interval t₀. For instance, the playback device 104 may analyze the frequency ranges of 2-5 kHz, 5-10 kHz, 10-15 kHz, and 15-20 kHz. Each of the frequency ranges of the expected audio response may exhibit some degree of reverberation. That is, the playback device 104 may record “echoes” of sounds that are emitted from the playback device 106 along with the sounds themselves. Echoes corresponding to each frequency range of the expected audio response may persist for an average amount of time. If the corresponding echoes in the audio recorded during the time interval t₁ persist on average significantly longer or decay significantly faster than those of the expected audio response recorded during the time interval t₀, the playback device 104 may determine that the calibration setting of the playback device 106 is invalid.

By further example, if echoes corresponding to any of the frequency ranges 2-5 kHz, 5-10 kHz, 10-15 kHz, and 15-20 kHz of the recorded audio persist 10% longer or shorter than corresponding echoes of the expected audio response, the playback device 104 may determine that the calibration setting of the playback device 106 is invalid. Other example frequency ranges, threshold numbers or percentages of frequency ranges, and threshold echo time differences are possible.

In some examples, the playback device 104 may determine that the playback device 104 does not detect any other playback device playing the audio before it determines whether the calibration setting of the playback device 106 is invalid. The playback device 104 may perform the determination of whether the calibration setting of the playback device 106 is invalid in response to determining that no other playback device within the environment of the playback device 104 is playing the audio at the same time. For example, the playback device 104 may be capable of detecting audio that any of the playback devices 108, 110, 112, or 114 are playing. This may ensure that any subsequent audio that is recorded and analyzed by the playback device 104 is played by the playback device 106 and not played by other playback devices within the environment.

In some examples, the playback device 104 might determine that its own calibration setting is invalid based on audio played and recorded by the playback device 104 as part of a process to check calibration settings of the playback device 104.

At block 506, the method 500 includes, in response to determining that the calibration setting is invalid, sending an indication that the calibration setting is invalid. For example, the playback device 104 may send an indication that the calibration setting of the playback device 106 is invalid. The indication may be sent to the control device 126, the playback device 106, or another computing device. The indication may be sent wirelessly, but other examples are possible.

In some examples, the playback device 106 may initiate a re-calibration process based on receiving the indication from the playback device 104. For example, the indication sent by the playback device 104 may include a command for the playback device 106 to initiate a re-calibration process and the playback device 106 may initiate the re-calibration process based on receiving the command.

In some examples, in addition to or instead of sending the indication that the calibration setting of the playback device 106 is invalid, the playback device 104 may store data indicating that the calibration setting of the playback device 106 is invalid. The data stored by the playback device 104 may be sent to another device or otherwise used at a later time.

In some examples, the playback device 104 may initiate its own re-calibration based on the playback device 104 determining that the calibration setting of the playback device 104 is invalid.

In some examples, audio played by the playback device 106 and recorded by the playback device 104 prior to performance of block 502 may be “low-resolution” audio content. This might mean that that the low-resolution audio content does not include, for at least a threshold amount of frequency ranges between 20 Hz-20 kHz, sound intensities that are greater than a threshold intensity. The threshold intensity may correspond to a minimum sound intensity that the playback device 104 can detect using its microphone at that given frequency range, but other examples are possible.

The playback device 104 may use the recorded low-resolution audio content to determine that that the calibration setting of the playback device 106 might be invalid. However, based on the playback device 104 determining that the low-resolution audio content is indeed low-resolution audio content, the playback device 104 may send a command for the playback device 106 to play “high-resolution” content, for example, the audio content played by the playback device 106 in some embodiments of block 502. Such high-resolution audio content may include, for at least a threshold amount of frequency ranges between 20 Hz-20 kHz, sound intensities that are greater than a threshold intensity. The playback device 104 may record and evaluate the high-resolution audio content played by the playback device 106 and, based on evaluating the high-resolution audio content, determine whether the calibration setting of the playback device 106 is invalid.

In some examples, the playback device 104 may repeat performance of the blocks 502 and 504 in order to verify that the calibration setting of the playback device 106 is invalid. For example, in a first iteration, the playback device 104 may record audio played by the playback device 106 and tentatively determine that the calibration setting of the playback device 106 is invalid. The playback device 104 may wait a predetermined amount of time and then record additional audio played by the playback device 106 and, based on the additional recorded audio, determine whether the calibration setting of the playback device 106 is invalid. Repeating the calibration check procedure helps ensure that the audio played and recorded prior to t₁ is not an “outlier” that falsely indicates that the calibration setting of the playback device 106 is invalid. Such outlier measurements may be due to transient changes to the environment and/or positioning of the playback device 106. The calibration check procedure may be repeated any number of times to further increase confidence that an evaluation of the calibration setting is accurate.

In some examples, perhaps after performing the method 500, the playback device 104 may determine that the playback device 104 has become unable to properly evaluate the calibration setting of the playback device 106. For example, the playback device 104 might detect movement of the playback device 104, meaning that audio recorded by the playback device 104 might no longer be reliable for checking the calibration of the playback device 106. In another example, the playback device 104 might determine that the calibration setting of the playback device 104 is no longer valid, which may also indicate that the playback device 104 is no longer reliable to evaluate the calibration setting of the playback device 106. If the playback device 104 determines that the playback device 104 is no longer able to properly evaluate the calibration setting of the playback device 106, the playback device 104 may send a command to another playback device (e.g., the playback device 108) to perform calibration evaluation procedures that were previously being performed by the playback device 104.

Referring to FIG. 6, in some examples the method 600 may be performed by a control device such as the control device 126, but other examples are possible.

At block 602, the method 600 includes receiving, from a first playback device, an indication that a calibration setting of a second playback device is invalid. For example, the control device 126 may receive, from the playback device 104, an indication that a calibration setting of the playback device 106 is invalid. The playback device 104 may determine that the calibration setting of the playback device 106 is invalid by any method described above with reference to block 504. In some examples, the indication might be received from the playback device 106. Other examples are possible as well.

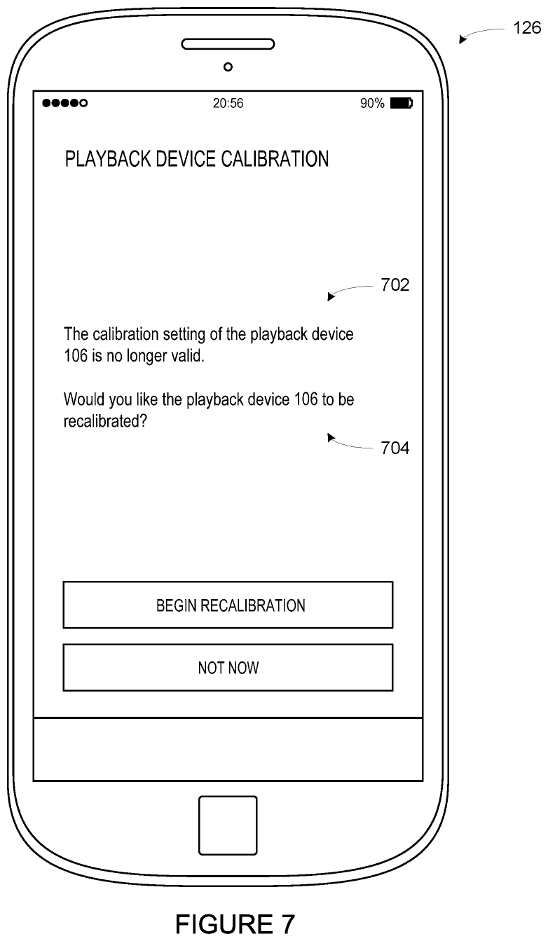

At block 604, the method 600 includes, based on the received indication, displaying an indication that the calibration setting of the second playback device is invalid. Referring to FIG. 7 for example, the control device 126 may display an indicator 702 that reads “The calibration setting of the playback device 106 is no longer valid.” The control device 126 may display other forms of indicators communicating that the calibration setting of the playback device 106 is invalid as well.

At block 606, the method 600 includes receiving input representing a command for the second playback device to be recalibrated and, at block 608, the method 600 includes sending instructions for the second playback device to be recalibrated. For example, the control device 126 may also display a prompt 704 that reads “Would you like the playback device 106 to be recalibrated?” If the control device 126 receives input at the selectable icon labeled “BEGIN RECALIBRATION,” the control device 126 may send, to the playback device 106 or another device, instructions for the playback device 106 to be recalibrated. Accordingly, the playback device 106 or the other device that received the instructions may cause the playback device 106 to initiate a re-calibration procedure.

### IV. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The Specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A first playback device comprising:
a communication interface;
at least one processor; and
at least one non-transitory computer-readable medium comprising program instructions that are executable by the at least one processor such that the first playback device is configured to:
while the first playback device and a second playback device are calibrated with particular calibration settings configured to produce particular multi-channel audio output when the first playback device and the second playback device are at respective first positions and orientations within an environment, play back first audio via two or more first transducers of the first playback device and at least one second audio transducer of the second playback device;
capture, via one or more microphones of the first playback device, playback of the first audio;
determine that the captured first audio indicates that at least one of the first playback device and the second playback device are in respective second positions and orientations within the environment; and
based on the determination, output an indication that the particular calibration settings are invalid.

2. The first playback device of claim 1, wherein the at least one non-transitory computer-readable medium further comprises program instructions that are executable by the at least one processor such that the first playback device is configured to:
perform a calibration to determine the particular calibration settings.

3. The first playback device of claim 2, wherein the program instructions that are executable by the at least one processor such that the first playback device is configured to perform the calibration comprise program instructions that are executable by the at least one processor such that the first playback device is configured to:
capture, via at least one microphone, calibration audio played back by the first playback device and the second playback device; and
determine the particular calibration settings based on the captured calibration audio.

4. The first playback device of claim 2, wherein the at least one non-transitory computer-readable medium further comprises program instructions that are executable by the at least one processor such that the first playback device is configured to:
after output of the indication that the particular calibration settings are invalid, receive, via the communications interface, data representing a command to re-calibrate; and
initiate another instance of the calibration according to the command.

5. The first playback device of claim 1, wherein the program instructions that are executable by the at least one processor such that the first playback device is configured to output the indication that the particular calibration settings are invalid comprise program instructions that are executable by the at least one processor such that the first playback device is configured to:
send, via the communications interface, data that causes a mobile device to output the indication that the particular calibration settings are invalid.

6. The first playback device of claim 1, wherein the program instructions that are executable by the at least one processor such that the first playback device is configured to output the indication that the particular calibration settings are invalid comprise program instructions that are executable by the at least one processor such that the first playback device is configured to:
output, via at least one audio transducer, an audio indication that the particular calibration settings are invalid.

7. The first playback device of claim 1, wherein the first playback device is integral to a television.

8. At least one non-transitory computer-readable medium comprising program instructions that are executable by at least one processor such that a first playback device is configured to:
while the first playback device and a second playback device are calibrated with particular calibration settings configured to produce particular multi-channel audio output when the first playback device and the second playback device are at respective first positions and orientations within an environment, play back first audio via two or more first transducers of the first playback device and at least one second audio transducer of the second playback device;
capture, via one or more microphones of the first playback device, playback of the first audio;
determine that the captured first audio indicates that at least one of the first playback device and the second playback device are in respective second positions and orientations within the environment; and
based on the determination, output an indication that the particular calibration settings are invalid.

9. The at least one non-transitory computer-readable medium of claim 8, wherein the at least one non-transitory computer-readable medium further comprises program instructions that are executable by the at least one processor such that the first playback device is configured to:
perform a calibration to determine the particular calibration settings.

10. The at least one non-transitory computer-readable medium of claim 9, wherein the program instructions that are executable by the at least one processor such that the first playback device is configured to perform the calibration comprise program instructions that are executable by the at least one processor such that the first playback device is configured to:
capture, via at least one microphone, calibration audio played back by the first playback device and the second playback device; and
determine the particular calibration settings based on the captured calibration audio.

11. The at least one non-transitory computer-readable medium of claim 9, wherein the at least one non-transitory computer-readable medium further comprises program instructions that are executable by the at least one processor such that the first playback device is configured to:
after output of the indication that the particular calibration settings are invalid, receive, via a communications interface, data representing a command to re-calibrate; and
initiate another instance of the calibration according to the command.

12. The at least one non-transitory computer-readable medium of claim 8, wherein the program instructions that are executable by the at least one processor such that the first playback device is configured to output the indication that the particular calibration settings are invalid comprise program instructions that are executable by the at least one processor such that the first playback device is configured to:
send, via a communications interface, data that causes a mobile device to output the indication that the particular calibration settings are invalid.

13. The at least one non-transitory computer-readable medium of claim 8, wherein the program instructions that are executable by the at least one processor such that the first playback device is configured to output the indication that the particular calibration settings are invalid comprise program instructions that are executable by the at least one processor such that the first playback device is configured to:
output, via at least one audio transducer, an audio indication that the particular calibration settings are invalid.

14. The at least one non-transitory computer-readable medium of claim 8, wherein the first playback device is integral to a television.

15. A method comprising:
while a first playback device and a second playback device are calibrated with particular calibration settings configured to produce particular multi-channel audio output when the first playback device and the second playback device are at respective first positions and orientations within an environment, playing back first audio via two or more first transducers of the first playback device and at least one second audio transducer of the second playback device;
capturing, via one or more microphones of the first playback device, playback of the first audio;
determining that the captured first audio indicates that at least one of the first playback device and the second playback device are in respective second positions and orientations within the environment; and
based on the determination, outputting an indication that the particular calibration settings are invalid.

16. The method of claim 15, further comprising:
performing a calibration to determine the particular calibration settings.

17. The method of claim 16, wherein performing the calibration comprises:
capturing, via at least one microphone, calibration audio played back by the first playback device and the second playback device; and
determining the particular calibration settings based on the captured calibration audio.

18. The method of claim 16, further comprising:
after output of the indication that the particular calibration settings are invalid, receiving, via a communications interface, data representing a command to re-calibrate; and
initiating another instance of the calibration according to the command.

19. The method of claim 15, wherein outputting the indication that the particular calibration settings are invalid comprises:
sending, via a communications interface, data that causes a mobile device to output the indication that the particular calibration settings are invalid.

20. The method of claim 15, wherein outputting the indication that the particular calibration settings are invalid comprises:
outputting, via at least one audio transducer, an audio indication that the particular calibration settings are invalid.
